(19) United States
(12) Patent Application Publication
(10) Pub. No.: US 2024/0330694 A1
(43) Pub. Date: Oct. 3, 2024

(54) POLYMER DISCOVERY VIA REINFORCEMENT LEARNING WITH EXPERT-DEFINED LOGICAL ACTIONS

(71) Applicant: International Business Machines Corporation, Armonk, NY (US)

(72) Inventors: Sarathkrishna Swaminathan, Santa Clara, CA (US); Tim Erdmann, San Jose, CA (US); Dmitry Zubarev, San Jose, CA (US); Subhajit Chaudhury, White Plains, NY (US); Asim Munawar, Demarest, NJ (US)

(21) Appl. No.: 18/127,952

(22) Filed: Mar. 29, 2023

(51) Int. Cl. G06N 3/092

(52) U.S. Cl. CPC G06N 3/092

(57) ABSTRACT

A reward-based reinforcement learning (RL) computing environment with an RL agent has a goal to discovery new polymers. The RL environment is integrated with a logical optimal action (LOA) framework that includes a logical neural network (LNN). The RL environment and the LOA framework share a user interface that switches between the LOA framework and the RL environment. At the LOA interface, polymer datasets are entered into the LOA framework along with subject matter expert (SME)-defined rules that limit the scope of the information in the datasets. The datasets and the SME-defined rules train the LNN to develop policy rules. Upon training completion, the datasets and the LNN policy rules are input into the RL environment where the RL agent makes reward-based decisions on the information in the datasets that advance the goal. At the RL interface, the SME reviews the RL agent's decisions to eliminate decisions that do not advance the goal.

### TECHNICAL FIELD

The present invention relates generally to polymer discovery, and more specifically to a computer-implemented system for discovering polymer that integrates a logical optimal action framework within a reinforcement learning artificial intelligence computing environment.

### BACKGROUND OF THE INVENTION

Polymer discovery is a multi-step sequential process that entails decisions and success evaluations at each stage of the discovery process. Example of decisions include choice of monomers, catalysts, polymerization conditions and protocols, post-polymerization processing, formulations, and material treatments. The multi-stage, multi-dimensional nature of the discovery process translates into a number of discovery experiments and accessible polymers that far exceed realistic time and budget constraints. The key to discovery a successful polymer lies in the ability to make meaningful options at each stage of the polymer discovery process. Application of artificial intelligence (AI) techniques for sequential decision-making, such as reinforcement learning (RL), provides a promising technique to increase the quality and efficiency of polymer discovery. Because RL does not use training data, but rather, learns through the process of rewards for useful decisions, the lack of external constraints on the input data in an RL environment results in useless decisions where there is no reward in addition to useful decisions that result in an award. In order to unlock the practical impact of RL on polymer discovery, there is a need in the art to (1) overcome sample inefficiency associated with the requirement for enormous training data; (2) add a reasoning capability to standard RL approaches in order to avoid useless decisions, and (3) ascertain access to conceptual scientific knowledge that is not reflected in data that is amenable to mining approaches.

### SUMMARY OF THE INVENTION

The present invention overcomes the need in the art by providing an RL environment comprising an RL agent that will make reward-based decisions, wherein the RL environment is integrated with a logical optimal action (LOA) framework comprising a logical neural network (LNN) that develops policy rules based upon a large polymer training dataset whose scope is constrained by rules provided by a subject matter expert (SME). The RL agent uses the policy rules to make decisions on the dataset that advance the polymer discovery goal. To ensure success of the RL agent, the SME reviews the RL agent's decisions to eliminate useless decisions that do not advance the polymer discovery goal, thus further ensuring the RL agent's polymer discovery success.

In one embodiment, the present invention relates to a system comprising: an RL computing environment comprising an RL algorithm acting as a reward-based RL agent programmed to make decisions in furtherance of a goal relating to the discovery of new polymer materials; and a logical optimal action (LOA) computing framework integrated with the RL computing environment, wherein the LOA computing framework comprises (1) an interface for entry of (i) at least one dataset comprising information relating to existing polymers and (ii) constraining rules that limit the scope of the information in the at least one dataset, and (2) a logical neural network (LNN) that is trained on the at least one dataset and the constraining rules and establishes LNN policy rules based on the training, wherein the at least one dataset and the LNN policy rules are input into the RL computing environment where the RL agent makes decisions on the information in the at least one dataset that comply with the LNN policy rules and the RL agent is rewarded for decisions that advance the goal.

In another embodiment, the present invention relates to a system comprising: an RL computing environment comprising an RL algorithm acting as a reward-based RL agent programmed to make decisions in furtherance of a goal relating to the discovery of new polymer materials; and an LOA computing framework integrated with the RL computing environment, wherein the LOA computing framework comprises (1) an interface for entry of (i) at least one dataset comprising information relating to existing polymers, and (ii) rules defined by an SME that constrain the scope of the at least one dataset to available materials and laboratory equipment, and (2) an LNN that is trained on the at least one dataset and the SME-defined constraining rules and establishes LNN policy rules based on the training, wherein the at least one dataset and the policy rules are input into the RL computing environment where the RL agent makes decisions on the information in the at least one dataset that comply with the LNN policy rules and the RL agent is rewarded for decisions that advance the goal.

In a further embodiment, the present invention relates to a computer-implemented method comprising: programming an RL algorithm to act as a reward-based RL agent within an RL computing environment, wherein the RL agent makes decisions in furtherance of a goal relating to the discovery of new polymer materials; and integrating LOA computing framework with the RL computing environment, wherein the LOA computing framework comprises (1) an interface for entry of (i) at least one dataset comprising information relating to existing polymers and (ii) constraining rules that limit the scope of the information in the at least one dataset, and (2) an LNN that is trained on the at least one dataset and the constraining rules and establishes LNN policy rules based on the training, wherein the at least one dataset and the LNN policy rules are input into the RL computing environment where the RL agent makes decisions on the information in the at least one dataset that comply with the LNN policy rules and the RL agent is rewarded for decisions that advance the goal.

In another embodiment, the present invention relates to a computer-implemented method comprising: programming an RL algorithm to act as a reward-based RL agent within an RL computing environment, wherein the RL agent makes decisions in furtherance of a goal relating to the discovery of new polymer materials; and integrating an LOA computing framework with the RL computing environment, wherein the LOA computing framework comprises (1) an interface for entry of (i) at least one dataset comprising information relating to existing polymers, and (ii) rules defined by an SME that constrain the scope of the at least one dataset to available materials and laboratory equipment, and (2) an LNN that is trained on the at least one dataset and the SME-defined constraining rules and establishes LNN policy rules based on the training, wherein the at least one dataset and the policy rules are input into the RL computing environment where the RL agent makes decisions on the information in the at least one dataset that comply with the LNN policy rules and the RL agent is rewarded for decisions that advance the goal.

In a further embodiment, the present invention relates to a computer program product for discovery of polymers comprising: program instructions on or more computer readable storage media for establishing an RL computing environment comprising an RL algorithm acting as a reward-based RL agent programmed to make decisions in furtherance of a goal relating to the discovery of new polymer materials; and program instructions on or more computer readable storage media for establishing an LOA computing framework integrated with the RL computing environment, wherein the LOA computing framework comprises (1) an interface for entry of (i) at least one dataset comprising information relating to existing polymers and (ii) constraining rules that limit the scope of the information in the at least one dataset, and (2) an LNN that is trained on the at least one dataset and the constraining rules and establishes LNN policy rules based on the training, wherein the at least one dataset and the LNN policy rules are input into the RL computing environment where the RL agent makes decisions on the information in the at least one dataset that comply with the LNN policy rules and the RL agent is rewarded for decisions that advance the goal.

In a further embodiment, the LOA further comprises (3) an internal regressor that parses the at least one dataset into experiments and outcomes, wherein the LNN converts the experiments and outcomes into symbolic language understood by the RL agent.

In another embodiment, the LNN policy rules are updated to reflect decisions made by the RL agent that successfully advance the goal and the updated LNN policy rules direct future decisions by the RL agent to achieve the goal.

In a further embodiment, the SME reviews the decisions by the RL agent to eliminate decisions that do not advance the goal.

Additional aspects and/or embodiments of the invention will be provided, without limitation, in the detailed description of the invention that is set forth below.

### BRIEF DESCRIPTION OF THE DRAWINGS

FIG. 1 is schematic diagram illustrating the integration of an LOA framework (left) into an RL environment.

FIG. 2A is a graph showing the poly dispersity index (PDI) data for a spin-on-glass (SOG) polymer as predicted by the RL agent described herein versus experimental data for the predicted SOG polymer as measured experimentally.

FIG. 2B is a graph showing the molecular weight for the SOG polymers as predicted by the RL agent and as measured experimentally.

FIG. 3 is schematic diagram of a computer environment that may be used to implement the RL environment with the integrated LOA framework described herein.

### DETAILED DESCRIPTION OF THE INVENTION

Set forth below is a description of what are currently believed to be preferred aspects and/or embodiments of the claimed invention. Any alternates or modifications in function, purpose, or structure are intended to be covered by the appended claims. As used in this specification and the appended claims, the singular forms “a,” “an,” and “the” include plural referents unless the context clearly dictates otherwise. The terms “comprise,” “comprised,” “comprises,” and/or “comprising,” as used in the specification and appended claims, specify the presence of the expressly recited components, elements, features, and/or steps, but do not preclude the presence or addition of one or more other components, elements, features, and/or steps.

As used herein, the terms “artificial intelligence” and “AI” refers to a computer algorithm that learns through experience.

As used herein, the terms “reinforcement learning” and “RL” refer to an artificial intelligence computer algorithm that does not require labeled data or a training set; rather, the algorithm is trained (i.e., learns) by interacting with a dynamic environment in which it must perform a certain goal. As an RL algorithm interacts with its environment and attempts to achieve its goal, the RL algorithm receives feedback in the form of rewards, which the algorithm is programmed to maximize. Within an RL environment, rewards are typically points where a +1-point reward indicates a successful decision that advances a goal and a −1 point is an unsuccessful decision that does not advance a goal.

As used herein, the term “RL agent” refers to an autonomous entity that makes decisions within an RL computing environment in order to achieve goals programmed into the reward-based RL environment.

As used herein, the terms “logical neural networks” and “LNN” refer an AI protocol that combines neural network training (learning) with symbolic logic (reasoning), the latter of which is a way to represent logical expressions.

A neural network is an AI algorithm that is modeled after the human brain with a collection of simulated neurons. Each neuron is a node that is connected to other nodes via links that are analogous to biological axo-synapse dendrite connections. Each link has a weight, which determines the strength of one node's influence on another. Neural networks learn (i.e., are trained) by processing examples, each of which contains a known input and output forming probability weighted associations between the input and the output. In operation, a neural network groups unlabeled input data according to similarities among example inputs, automatically extracts features from the groups, clusters groups with similar features, and classifies output data when there is a labeled dataset for training. The patterns recognized by a neural network are numerical and contained in vectors, which must be translated. Examples of neural network vectors include without limitation, symbols, images, sound, text, time, or combinations thereof.

Logical expressions are natural language statements that have a truth value, which is either true or false. Symbolic logic uses symbols and variables in place of natural language in order to remove vagueness. Following is a non-limiting representative list of commonly used symbols used in symbolic logic:
p, q, r statements (e.g., “A triangle has three sides” or “perpendicular lines intersect” or “parallel lines never meet”);
V “or”;
A “and”;
˜ “it is not the case that”;
=> “implies” or “if . . . then . . . ”; and
↔ “implies and is implied by” or “if and only if”.

Using logical functions, an LNN can train constraints and rules in a neural network. Because every neuron in an LNN has a component for a formula of weighted real-value logics, the LNN can calculate the probability and contradiction loss for each proposition. An LNN has a 1-to-1 correspondence where there is one neuron for each logical operation or proposition occurring in a formula.

As used herein, the term “subject matter expert” and “SME” refers to the operator of an AI platform that provides the knowledge and expertise for the AI platform to be able to learn. Within the context of the present invention, the SME will provide the constraining rules that will train an LNN and will review the decisions made by an RL agent within the RL environment.

As used herein, the terms “logical optimal action” and “LOA” refers to a neuro-symbolic LNN and a natural language component that is capable of optimizing the actions of the LNN. With the present invention, the optimization of the LNN approach is carried out by the SME that provides the rules that constrain the LNN training data.

As used herein the term “hard rules” refers to the following rules, which are provided by an SME to an AI platform: predicates, logical operations, and weights.

As used herein, the term “soft rules” refers to the following rules, which are provided by an SME to an AI platform: predicates and logical operations. With soft rules, weights are not provided, but are learned during training.

Described herein is an RL environment comprising an RL agent, wherein the RL environment is integrated with an LOA framework comprising an LNN. Because RL algorithms are not trained with datasets, but learn through game-playing, the RL environment of the present invention is tailored via data manipulation at the integrated LOA framework. In application, one or more large datasets of training data relating to accessible polymers and polymer discovery experiments are provided to the LNN within the LOA framework along with SME-defined hard and soft constraining rules that limit the scope of the one or more datasets during analysis.

Examples of polymer databases include that may be entered into the LOA framework include, without limitation, PI1M database (accessible at http://github.com/RUIMINMA1996/PI1M), EBSCO Polymer Library (accessible at https://www.ebsco.com/products.research-datanases/polymer-library), RadonPy (accessible at https://github.com/RadonPy/RadonPy), and ChemProp (accessible at https://github.com/chemprop/chemprop).

Examples of constraining rules that may be entered into the LOA framework by the SME include, without limitation, available materials, available experimental equipment, specific purposes for the polymer, and combinations thereof.

Once the LNN within the LOA framework is trained with the polymer data and the constraining rules and has established the LNN policy rules that will guide the RL agent decision-making, the dataset and the LNN policy rules are fed into the RL environment where the RL agent makes reward-based decisions designed to achieve the goal of discovering polymers that are capable of synthesis with available laboratory equipment and materials. To further assist the RL agent in making decisions that advance the goal, the SME reviews the RL agent's decisions and eliminates any decisions that do not advance the game via rewards (i.e., decisions that do not advance the polymer discovery goal are eliminated).

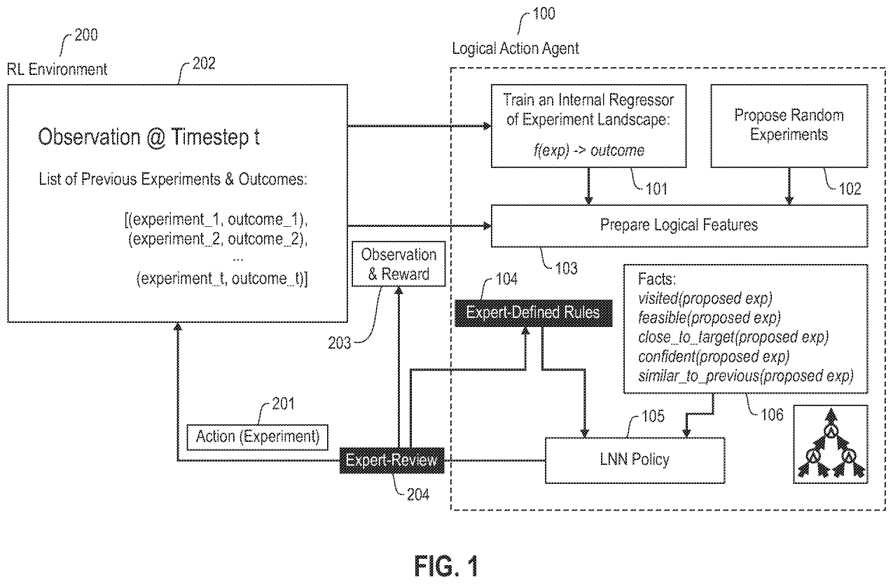

FIG. 1 is a schematic representation of the computer-implemented polymer discovery system showing the RL environment 200 on the left and the LOA framework 100 on the right, the latter of which includes an internal regressor and an LNN. Starting within the LOA framework, the LNN training begins with the entry of a large polymer training dataset 101 that includes random experiments 102 into the internal regressor where a 1:1 correlation between experiments and outcomes is carried out according to Formula (1):

f(exp)outcome. (1)

The correlated data is next input into the LNN 103, which assigns a symbol to each experiment and each outcome as logical features. In order to make the logical features of the large training dataset more manageable for the RL environment, it is constrained within the LNN via SME review and the integration of SME-defined rules 104. For example, an SME-defined rule may limit the molar fraction of reactants, the molar ratio of acidic catalyst to reactive groups, the molar ratio of water to reactive groups, and the volume of solvent in the experimental procedure as provided in Formula (2):

0.05≤x(reactant1)≤1.0; and

0.01≤n(catalyst)/n(reactive groups)≤0.1; and

0.5≤n(water)/n(reactive groups)≤3; and

n(total reactants)/c(high)≤V(solvent)≤n(total reactants)/c(low) with c(high)=5 mol/L and c(low)=0.5 mol/L. (2)
where n is amount in moles, x is molar fraction, V is volume, and c is concentration.

It is to be understood that the upper and lower limits shown in Formula 2 are merely illustrative and that the upper and lower limits will vary depending upon the specific reactions that the SME-defined rules are meant to address.

With continued reference to FIG. 1, the LNN uses the SME-defined rule, in this case of Formula (2), to develop an LNN policy 105 that provides the RL environment 200 with a more narrowly tailored dataset 201 for the RL agent to begin the game of discovering polymers 202 for synthesis. As the RL agent begins its reward-based game 203, the SME 204 may review the RL agent's decision to eliminate useless decisions that do not advance the goal of the game. The useful decisions of the RL agent are provided back to the LOA framework where the LNN further refines the polymer discovery dataset to incorporate “facts” 106. Examples of such facts include information relating to the experiments and their outcomes in the dataset, such as, for example, proposed experiments that were visited, are feasible, have outcomes that are close to the target, are confident to produce a successful outcome, and are similar to previous experiments (e.g., duplicates). The LNN uses these facts to refine the LNN policy rule 105 that is sent back to the RL agent 200 for continued reward play 203. When the SME-defined rule shown above is combined with the learned LNN fact list (i.e., the LNN-learned rules), the LNN produces the LNN-learned policy rule defined by Formula (3):

visited(exp) and feasible(exp) and close_to_target(exp). (3)

Applying the policy of Formula (3), a non-limiting example of a constraining SME-defined hard rule (which includes predicates, logical operations, and weights) is:
0.33 not-visited(exp) AND 0.33 feasible(exp) AND 0.33 requires water vol (exp)>0.2%.

A non-limiting example of an SME-constraining soft rule (which includes predicates and logical operations, but not weights, the latter of which are learned later during training) is:
not-visited(exp) AND feasible(exp) AND confident(exp) AND require water vol (exp)>0.2%.

The SME's review of the RL agent's actions within the RL environment has many advantages. As noted above, the SME's review ensures that any useless actions that do not advance the goal of the game do not get executed by the RL agent. Direct feedback from the SME for such actions helps the RL agent to learn to avoid executing similar actions in the future through the feedback loop where the LNN-learned policy rule is updated with the results provided by the RL agent to the LOA framework and the subsequent revision of the LNN-learned policy rule to incorporate additional results received from the RL agent.

In addition to providing efficient and logical learning of the RL agent through the training provided at the integrated LOA framework and the guidance provided by the SME, the polymer discovery system also has the ability to discover scientifically explainable alternatives to the decisions proposed by the SME. Through its learning process where decisions are directed by the LNN policy rules and poor decisions are eliminated by the SME, the RL agent can learn to mine the dataset to propose procedures for polymer synthesis that go beyond the guidance provided by, and knowledge known by, the SME.

In application, the RL environment and the LOA framework shown in FIG. 1 will exist within a single user interface where the user may switch between the LOA framework in order implement the LNN training and enter the SME-directed rules and the RL environment where the agent takes actions and receives rewards. For example, within a single user interface such as a dashboard, the LOA framework and the RL environment may be accessed in tiles or cards components of the dashboard. User input may be provided via keyboard and/or mouse actions, in the form of text and/or voice, and may additionally be supported by SME interaction with a conversational agent. In one embodiment, the user interface may further separate the LNN training such that the LOA framework includes one view that shows the LNN policy rules that are used to assist the RL agent in decision-making and another view that shows the results of the trained LNN.

Examples of software programs that can be used to build the RL environment and the integrated LNN of the LOA framework include, without limitation, Pytorch, OpenAI Gym, TensorFlow, Keras, Theano, Caffe, and DeepMind Lab. The programming language used to run the software program will depend upon the compatibility of the programing language with the software program. Examples of common programming languages include, without limitation, Python, C++, JavaScript, Go, Perl, PHP, Ruby, Lua, Torch, Swift, TypeScript, SQL, and Shell. Example 1 provides an outline of an exemplary LOA framework and RL environment as described herein.

The LOA framework may be used to train the RL agent to predict the parameters for new polymers using any technique known in the art including, without limitation, sol-gel, liquid-mix (also known as the Pechini method), and precipitation polymerization. Following is a discussion of the application of the RL/LOA for polymer discovery using sol-gel as an illustrative example.

Sol-gel is a process for producing solid materials as inorganic polymeric networks from small molecules. The process involves conversion of monomers into a colloidal solution (the sol) that acts as the precursor for an integrated network (the gel) of either discrete particles or network polymers. The sol-gel process has application in the following industries to produce materials: chemical, biotechnological, optical, construction, automotive, aerospace, pharmaceutical, cosmetic, analytical, and medicine and gives access to dense thin-films presently not accessible by any other method. Examples of dense thin-films and materials formed through sol-gel are spin-on glass (SOG, which is a thin film of silicon dioxide used in the manufacture of electronic components), ceramic membranes, bone-grafting media, coatings for metal implants, metal-oxide semiconductors for gas sensing and catalysts, materials for controlled release of pharmaceuticals and therapeutics, fragrances, biocides, and wear-resistant coatings. The versatility of the sol-gel process lies in the ability of the process to form various materials from a choice of starting materials, catalysts, synthesis conditions, and post-processing.

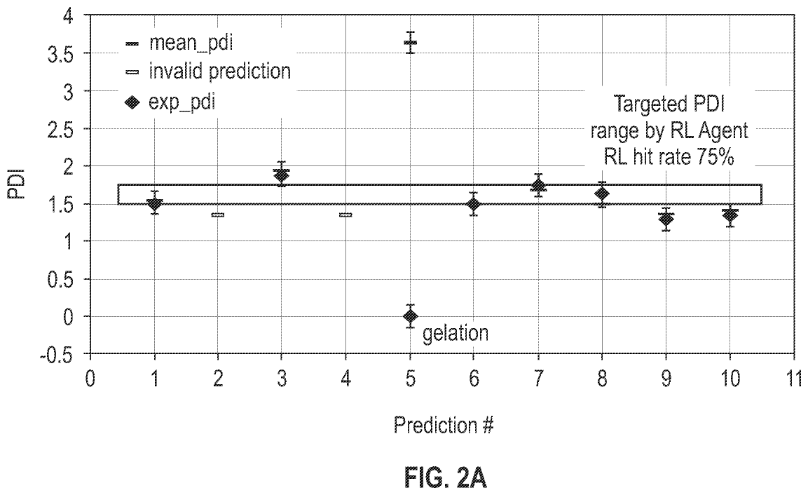

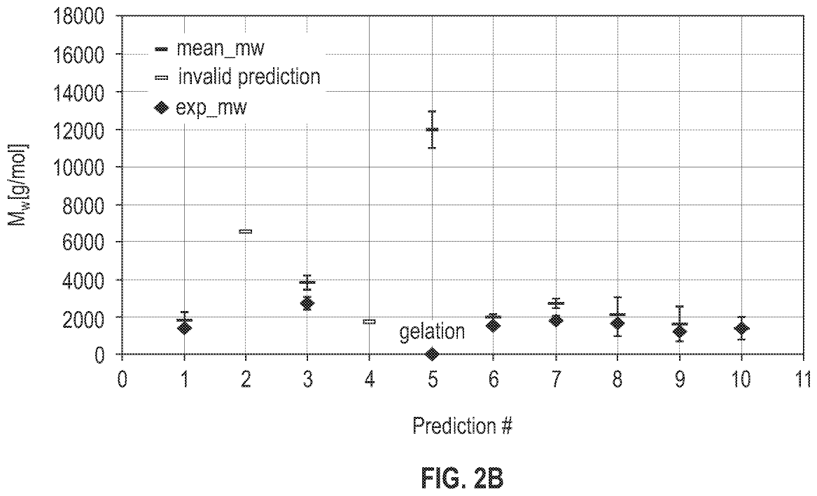

FIG. 2A is a graph plotting the RL agent predicted (rectangles) poly dispersity index (PDI) for 10 samples of SOG, which were experimentally validated, and FIG. 2B shows the molecular weights for the same ten samples. Example 1 describes the procedure used to build the RL environment and LOA framework for the SOG experiments, Example 2 describes the procedure used to train the RL agent to produce the results shown in FIGS. 2A and 2B, and Example 3 describes the general sol-gel process and the procedure that was used to validate the sol-gel parameters predicted by the RL agent to produce the SOG. The conditions for the synthesis of the SOG as described in Example 2 were proposed by the RL agent pursuant to the SME-defined conditions of Formula (2) and the LNN-learned policy rule of Formula (3) where the conditions were reviewed by a SME. The PDI of the 10 predicted SOG samples were calculated by the RL agent pursuant to the data that was provided to the RL environment from the LOA framework (which included SME review and guidance). As shown in FIG. 2A, the RL agent predicted a PDI of 1.5-1.75 for Samples 1-10. The predicted PDI had 75% accuracy demonstrating that the RL agent had a learned understanding of the reactant's molar fraction, and the molar ratio of catalyst to reactive groups at a constant amount of water and reagent concentrations in the SOG reaction.

In one embodiment, the present invention comprises an RL computing environment comprising an RL algorithm acting as a reward-based RL agent programmed to make decisions in furtherance of a goal relating to the discovery of new polymer materials; and an LOA computing framework integrated with the RL computing environment, wherein the LOA computing framework comprises (1) an interface for entry of (i) at least one dataset comprising information relating to existing polymers and (ii) constraining rules that limit the scope of the information in the at least one dataset, and (2) an LNN that is trained on the at least one dataset and the constraining rules and establishes LNN policy rules based on the training, wherein the at least one dataset and the LNN policy rules are input into the RL computing environment where the RL agent makes decisions on the information in the at least one dataset that comply with the LNN policy rules and the RL agent is rewarded for decisions that advance the goal.

In another embodiment, the present invention comprises an RL computing environment comprising an RL algorithm acting as a reward-based RL agent programmed to make decisions in furtherance of a goal relating to the discovery of new polymer materials; and LOA computing framework integrated with the RL computing environment, wherein the LOA computing framework comprises (1) an interface for (i) entry of at least one dataset comprising information relating to existing polymers, and (ii) entry of rules defined by an SME that constrain the scope of the at least one dataset to available materials and laboratory equipment, and (2) an LNN that is trained on the at least one dataset and the SME-defined constraining rules and establishes LNN policy rules based on the training, wherein the at least one dataset and the policy rules are input into the RL computing environment where the RL agent makes decisions on the information in the at least one dataset that comply with the LNN policy rules and the RL agent is rewarded for decisions that advance the goal.

In a further embodiment, the LOA further comprises (3) an internal regressor that parses the at least one dataset into experiments and outcomes, wherein the LNN converts the experiments and outcomes into symbolic language understood by the RL agent.

In another embodiment, the LNN policy rules are updated to reflect decisions made by the RL agent that successfully advance the goal and the updated LNN policy rules direct future decisions by the RL agent to achieve the goal.

In a further embodiment, the SME establishes the constraining rules and reviews the decisions by the RL agent to eliminate decisions that do not advance the goal.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

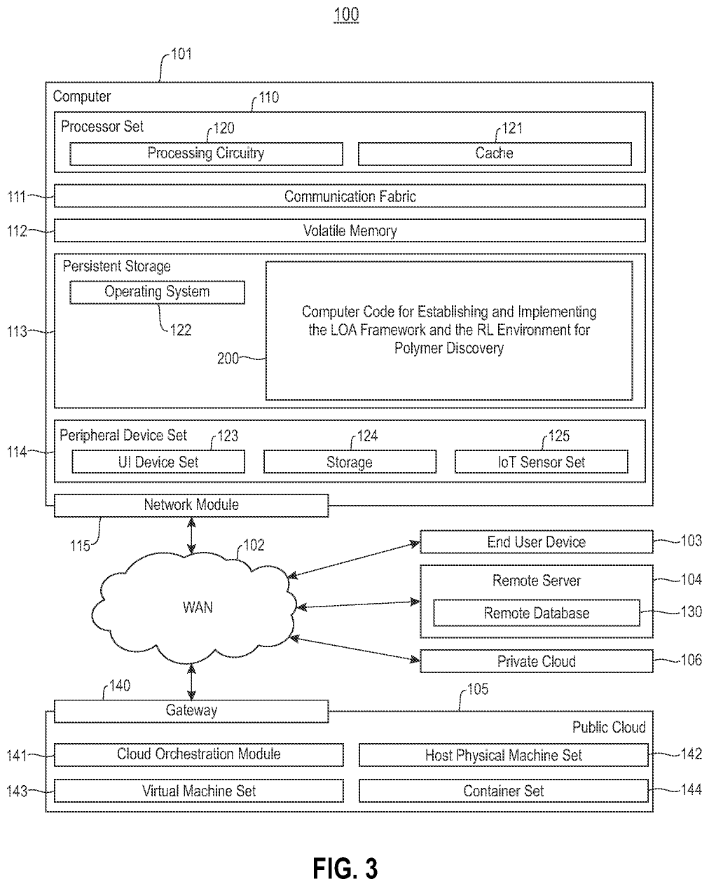

The following discussion refers to FIG. 3. Computing environment 100 contains an example of an environment for the execution of at least some of the computer code involved in performing the inventive methods, such as establishing and implementing the LOA framework and the RL environment for polymer discovery as described herein 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 3. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various aspects and/or embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the aspects and/or embodiments, the practical application or technical improvement over technologies found in the marketplace, or to enable others of ordinary skill in the art to understand the aspects and/or embodiments disclosed herein.

### EXPERIMENTAL

The following examples are set forth to provide those of ordinary skill in the art with a complete disclosure of how to make and use the aspects and embodiments of the invention as set forth herein. While efforts have been made to ensure accuracy with respect to variables, experimental error and deviations should be considered.

### Example 1

### Building the RL Environment and LOA Framework

The RL environment and LOA framework (referred to herein as “RL/LOA”) as described herein was built using the following two components:
(1) IBM's Polymer Discovery Environment (PDE) (accessible at https://github.com/IBM/logical-agent-driven-polymer-discovery) that simulates the behavior of a chemistry reaction system. Python and OpenAI Gym were used to implement the PDE. Within the PDE, GPy, scikit-learn, and forestci were used to implement the internal regressor; dill was used for saving the surrogate dataset; and numpy, pandas and matplotlib were used internally within the environment for handling data and plotting the state of the environment.
(2) An LNN-based RL agent and the algorithm used to train the agent based on the data that the agent collected by interacting with the PDE. Pytorch was used to implement and train the agent.

### Example 2

### Training the RL Agent on Spin-on Glass Reactions

Multiple LNN-based RL agents were trained on surrogate SOG reaction datasets using the RL/LOA as described in Example 1. The trained agents were benchmarked on unseen test surrogate reaction datasets with several material discovery specific evaluation metrics, including: average number of targets found, average number of steps to find first target reaction, and average % of invalid reactions. The best model obtained from the agent benchmarking was used to predict ten reaction settings for the 1.5-1.75 PDI range shown in FIGS. 2A and 2B. Example 3 describes the sol-gel procedure that was used to train the agents to predict key parameters for the SOG reaction.

### Example 3

### The Sol-Gel Procedure

### Materials

For the sol-gel process, all chemicals were acquired from Sigma-Aldrich and used as received. The following abbreviations are used for the sol-gel chemicals: tetraethyl orthosilicate (TEOS); phenyltriethoxysilane (PTES); maleic acid (MA); propylene glycol methyl ether (PGME). An aqueous solution of MA at a weight concentration of 27.6% was prepared by dissolving 30.16 g MA in distilled water and topping to 100 mL as total volume of the solution.

### Instrumentation

Sol-gel reactions were performed using the Scorpion Screen Builder (Art Robbins Instruments, Sunnyvale, CA, USA) single channel pipettor equipped with an additional hot plate and heating block rack. Molecular weights and molecular weight distribution were determined using a Waters 2695D (Waters Corporation, Pleasanton, CA, USA) equipped with an Optilab rEX (Wyatt Technology Corporation, Santa Barbara, CA, USA) differential refractometer, Waters HR-4E and HR-1 columns (Waters Corporation, Pleasanton, CA, USA), and tetrahydrofuran (THF) as the eluent. The system was equilibrated at 30° C. and measurements of filtered samples (filtered with a 0.5 μm polytetrafluoroethylene (PTFE) filter) were conducted at a flow rate of 1.0 mL/min. CONVERTING RL AGENT PREDICTED REACTION PARAMETERS TO EXPERIMENTALLY EXECUTABLE VALUES General procedure for sol-gel reactions

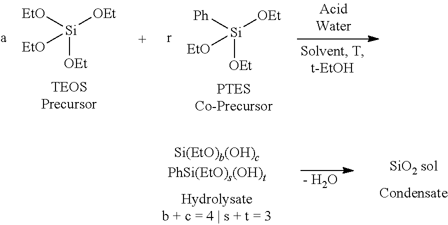 [SMILES: CCO[Si](OCC)(OCC)OCC ; CCO[Si](OCC)(OCC)c1ccccc1 ; "- H2O"]

Upon completion of the training for the sol-gel process, the RL agent reported 10 sets of sol-gel reaction parameters, such as various reactant ratios and concentrations, for a 1.5-1.75 target range of PDI values. Surrogate ensemble models were then employed to return statistical predictions for PDI and molecular weight values for each set as shown in FIGS. 2A and 2B. The reaction parameters for the predicted sets, which were reported in ratios and concentrations, were converted into respective volumes for each reactant of the sol-gel reaction, which was necessary due to the Scorpion tool being capable of only handling liquids.

A 4 mL screw cap glass vial was equipped with a stir bar, placed into the heating block element of the Scorpion tool, and preheated to 70° C. equipped with stir bars. Total volumes for the individual reactions were adjusted to 2.8-3.5 mL Reactant volumes were calculated according to the reaction parameters and added in the following order: MA solution (catalyst), water, PGME (solvent), TEOS (precursor), and PTES (co-precursor). Afterwards, the vial was closed and the stirring speed set to 400 rpm. 0.2 mL aliquots were taken from the reaction after 0.5, 1, 2, 3, and 4 hours and quenched in 2.3 mL THF. Gel permeation chromatograph (GPC) samples were prepared by further diluting the reaction samples to 3 mL and passing the solution through a 0.5 μm PTFE filter. Because Sample 5 produced a gel prior to measurement, that sample was not able to be validated as is shown in FIGS. 2A and 2B.

We claim:

1. A system comprising,
a reinforcement learning (RL) computing environment comprising an RL algorithm acting as a reward-based RL agent programmed to make decisions in furtherance of a goal relating to the discovery of new polymer materials; and
a logical optimal action (LOA) computing framework integrated with the RL computing environment, wherein the LOA computing framework comprises (1) an interface for entry of (i) at least one dataset comprising information relating to existing polymers and (ii) constraining rules that limit the scope of the information in the at least one dataset, and (2) a logical neural network (LNN) that is trained on the at least one dataset and the constraining rules and establishes LNN policy rules based on the training, wherein the at least one dataset and the LNN policy rules are input into the RL computing environment where the RL agent makes decisions on the information in the at least one dataset that comply with the LNN policy rules and the RL agent is rewarded for decisions that advance the goal.

2. The system of claim 1, wherein the constraining rules limit the scope of the information in the at least one dataset to available materials and laboratory equipment.

3. The system of claim 1, wherein the LOA further comprises (3) an internal regressor that parses the at least one dataset into experiments and outcomes, wherein the LNN converts the experiments and outcomes into symbolic language understood by the RL agent.

4. The system of claim 1, wherein the LNN policy rules are updated to reflect decisions made by the RL agent that successfully advance the goal and the updated LNN policy rules direct future decisions by the RL agent to achieve the goal.

5. The system of claim 1, wherein a subject matter expert (SME) establishes the constraining rules and reviews the decisions by the RL agent to eliminate decisions that do not advance the goal.

6. A system comprising:
a reinforcement learning (RL) computing environment comprising an RL algorithm acting as a reward-based RL agent programmed to make decisions in furtherance of a goal relating to the discovery of new polymer materials; and
a logical optimal action (LOA) computing framework integrated with the RL computing environment, wherein the LOA computing framework comprises (1) an interface for entry of (i) at least one dataset comprising information relating to existing polymers, and (ii) rules defined by a subject matter expert (SME) that constrain the scope of the at least one dataset to available materials and laboratory equipment, and (2) a logical neural network (LNN) that is trained on the at least one dataset and the SME-defined constraining rules and establishes LNN policy rules based on the training, wherein the at least one dataset and the policy rules are input into the RL computing environment where the RL agent makes decisions on the information in the at least one dataset that comply with the LNN policy rules and the RL agent is rewarded for decisions that advance the goal.

7. The system of claim 6, wherein the LOA further comprises (3) an internal regressor that parses the at least one dataset into experiments and outcomes, wherein the LNN converts the experiments and outcomes into symbolic language understood by the RL agent.

8. The system of claim 6, wherein the LNN policy rules are updated to reflect decisions made by the RL agent that successfully advance the goal and the updated LNN policy rules direct future decisions by the RL agent to achieve the goal.

9. The system of claim 6, wherein the SME reviews the decisions by the RL agent to eliminate decisions that do not advance the goal.

10. A computer-implemented method comprising,
programming a reinforcement learning (RL) algorithm to act as a reward-based RL agent within an RL computing environment, wherein the RL agent makes decisions in furtherance of a goal relating to the discovery of new polymer materials; and
integrating a logical optimal action (LOA) computing framework with the RL computing environment, wherein the LOA computing framework comprises (1) an interface for entry of (i) at least one dataset comprising information relating to existing polymers and (ii) constraining rules that limit the scope of the information in the at least one dataset, and (2) a logical neural network (LNN) that is trained on the at least one dataset and the constraining rules and establishes LNN policy rules based on the training, wherein the at least one dataset and the LNN policy rules are input into the RL computing environment where the RL agent makes decisions on the information in the at least one dataset that comply with the LNN policy rules and the RL agent is rewarded for decisions that advance the goal.

11. The computer-implemented method of claim 10, wherein the constraining rules limit the scope of the information in the at least one dataset to available materials and laboratory equipment.

12. The computer-implemented method of claim 10, wherein the LOA further comprises (3) an internal regressor that parses the at least one dataset into experiments and outcomes, wherein the LNN converts the experiments and outcomes into symbolic language understood by the RL agent.

13. The computer-implemented method of claim 10, wherein the LNN policy rules are updated to reflect decisions made by the RL agent that successfully advance the goal and the updated LNN policy rules direct future decisions by the RL agent to achieve the goal.

14. The computer-implemented method of claim 10, wherein a subject matter expert (SME) establishes the constraining rules and reviews the decisions by the RL agent to eliminate decisions that do not advance the goal.

15. A computer-implemented method comprising:
programming a reinforcement learning (RL) algorithm to act as a reward-based RL agent within an RL computing environment, wherein the RL agent makes decisions in furtherance of a goal relating to the discovery of new polymer materials; and
integrating a logical optimal action (LOA) computing framework with the RL computing environment, wherein the LOA computing framework comprises (1) an interface for entry of (i) at least one dataset comprising information relating to existing polymers, and (ii) rules defined by a subject matter expert (SME) that constrain the scope of the at least one dataset to available materials and laboratory equipment, and (2) a logical neural network (LNN) that is trained on the at least one dataset and the SME-defined constraining rules and establishes LNN policy rules based on the training, wherein the at least one dataset and the policy rules are input into the RL computing environment where the RL agent makes decisions on the information in the at least one dataset that comply with the LNN policy rules and the RL agent is rewarded for decisions that advance the goal.

16. The computer-implemented method of claim 15, wherein the LOA further comprises (3) an internal regressor that parses the at least one dataset into experiments and outcomes, wherein the LNN converts the experiments and outcomes into symbolic language understood by the RL agent.

17. The computer-implemented method of claim 15, wherein the LNN policy rules are updated to reflect decisions made by the RL agent that successfully advance the goal and the updated LNN policy rules direct future decisions by the RL agent to achieve the goal.

18. The computer-implemented method of claim 15, wherein the SME reviews the decisions by the RL agent to eliminate decisions that do not advance the goal.

19. A computer program product for discovery of polymers comprising:
program instructions on or more computer readable storage media for establishing a reinforcement learning (RL) computing environment comprising an RL algorithm acting as a reward-based RL agent programmed to make decisions in furtherance of a goal relating to the discovery of new polymer materials; and
program instructions on or more computer readable storage media for establishing a logical optimal action (LOA) computing framework integrated with the RL computing environment, wherein the LOA computing framework comprises (1) an interface for entry of (i) at least one dataset comprising information relating to existing polymers and (ii) constraining rules that limit the scope of the information in the at least one dataset, and (2) a logical neural network (LNN) that is trained on the at least one dataset and the constraining rules and establishes LNN policy rules based on the training, wherein the at least one dataset and the LNN policy rules are input into the RL computing environment where the RL agent makes decisions on the information in the at least one dataset that comply with the LNN policy rules and the RL agent is rewarded for decisions that advance the goal.

20. The computer program product of claim 19, wherein the constraining rules limit the scope of the information in the at least one dataset to available materials and laboratory equipment.

21. The computer program product of claim 19, wherein the LOA further comprises (3) an internal regressor that parses the at least one dataset into experiments and outcomes, wherein the LNN converts the experiments and outcomes into symbolic language understood by the RL agent.

22. The computer program product of claim 19, wherein the LNN policy rules are updated to reflect decisions made by the RL agent that successfully advance the goal and the updated LNN policy rules direct future decisions by the RL agent to achieve the goal.

23. The computer program product of claim 19, wherein a subject matter expert (SME) establishes the constraining rules and reviews the decisions by the RL agent to eliminate decisions that do not advance the goal.
